(19) United States
(12) Patent Application Publication
(10) Pub. No.: US 2010/0259644 A1
(43) Pub. Date: Oct. 14, 2010

(54) APPARATUS AND METHOD FOR PROCESSING IMAGE INFORMATION

(75) Inventors: Deok Gyu Lee, Kyunggi-do (KR); Yun Kyung Lee, Daejeon (KR); Geon Woo Kim, Daejeon (KR); Jong Wook Han, Daejeon (KR); Kyo Il Chung, Daejoen (KR); Jong Soo Jang, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/808,239

(22) PCT Filed: Sep. 11, 2008
(86) PCT No.: PCT/KR08/05399

§ 371 Date: Jun. 15, 2010

(30) Foreign Application Priority Data
Dec. 17, 2007 (KR) 10-2007-0132817

(51) Int. Cl. H04N 5/76; H04L 9/32

(52) U.S. Cl. 348/231.5; 713/176; 348/E05.022

(57) ABSTRACT

An apparatus and a method for processing image information are provided. The apparatus for processing image information includes an image capturing device and an image information server for receiving and storing an image captured by the image capturing device and adds information on the image capturing device and signature information to image data obtained by the image capturing device. Accordingly, the device information and the signature information can be added to the image data obtained by the image capturing device to maintain security of the image data and use the image data as digital proof when a specific event is generated.

### TECHNICAL FIELD

The present invention relates to an apparatus and a method for processing image information, and more particularly, to an image information processing apparatus and method capable of adding information on an image capturing device and signature information to image data and storing the image data to maintain security of the image data and use the image data as digital proof.

The present invention was supported by the IT R&D program of Ministry of Information and Communication(MIC) and Institute for Information Technology Advancement (IITA)[Project No.: 2006-S-067-02, Project Title: Development of ubiquitous home network security technology based on device authentication].

### BACKGROUND ART

With the development of image photographing technology, techniques for maintaining security of image data captured by an image capturing device and protecting copyright are proposed. For example, captured images are transmitted to a limited image information output device and reproduced or identification information such as watermarking is embedded in image data to protect copyright of image information.

In the case of embedding watermarking in image information, it is possible to confirm the copyright holder of the image information even though the image information is displayed at or transmitted to an undesired place and prevent the image information from being illegally copied. Furthermore, users can watch the image information without having any difficulty and track the source of the image information and image information copy routes when watermarking is embedded in the image information.

However, watermarking does not have legal force capable of preventing the image information from being illegally copied or transmitted although it can show the copyright holder or the source of the image information and allow users to confirm image information copy routes and the source of the image information. Accordingly, security of image information cannot be efficiently maintained only with watermarking when the image information includes personal information related to privacy or data requiring the maintenance of security.

### DISCLOSURE OF INVENTION

### Technical Problem

It is an object of the present invention to provide an image information processing apparatus and method for adding information on an image capturing device and predetermined signature information to image data obtained using the image capturing device to protect the image data from infringement of security such as illegal copy and transmission and adding information on the place and time at which the image data is obtained to the image data to use the image data as digital proof.

### Technical Solution

An apparatus for processing image information according to the present invention comprises: an image capturing unit for generating image data and collecting information on the image capturing unit; an image processing unit for adding at least one of the information on the image capturing unit and signature information to the image data using the image data and the information on the image capturing unit transmitted from the image capturing unit; and an image storage unit for storing the image data output from the image processing unit.

A method for processing image information according to the present invention comprises: an image capturing step of generating image data and collecting information on the image capturing step; an image processing step of adding at least one of the information on the image capturing step and signature information to the image data; and an image storing step of storing the image data.

An apparatus for processing image information using image data according to the present invention comprises: a device information unit for embedding information on the device that generates the image data in the image data; a signature information unit for embedding signature information in the image data; and a storage unit for storing the image data having at least one of the information on the device and the signature information added thereto.

A method for processing image information using image data according to the present invention comprises: a device information step of embedding information on the device that generates the image data in the image data; a signature information step of embedding signature information in the image data; and a storing step of storing the image data having at least one of the information on the device and the signature information added thereto.

### Advantageous Effects

The present invention can acquire image data included in a captured image and add information on the device that captures the image and signature information to the image data to efficiently maintain security of the image data and use a captured image with respect to a specific event as digital proof.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a configuration of an image photographing system to which an image information processing apparatus according to the present invention is applied;

FIG. 2 is a block diagram of an image capturing device 110 and an image information server 120 illustrated in FIG. 1 according to an embodiment of the present invention;

FIG. 3 is a block diagram of an image capturing device 110 and an image information server 120 illustrated in FIG. 1 according to another embodiment of the present invention; and

FIG. 4 is a flow chart of an image information processing method using the image photographing system illustrated in FIG. 1.

### BEST MODE FOR CARRYING OUT THE INVENTION

Hereinafter, an embodiment of the present invention will be described below with reference to the accompanying drawings.

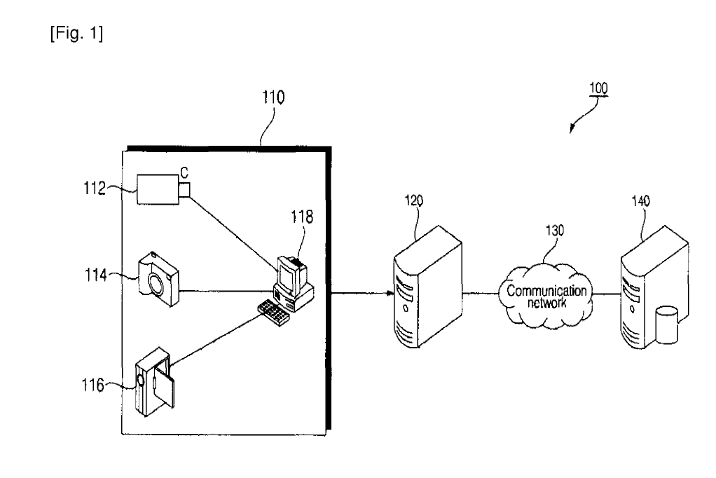

FIG. 1 is a view illustrating a configuration of an image photographing system to which an image information processing apparatus according to the present invention is applied. Referring to FIG. 1, the image photographing system includes an image capturing device 110 for capturing an image and converting the captured image into image data, an image information server 120 for receiving and storing the image data, and an application server 140 for providing various application services using the image data stored in the image information server 120.

The image capturing device 110 includes an imaging capturing unit 112 for converting an optical image formed through a lens into image data and an image processor 118 for receiving the image data and adding signature information or device information of the image capturing unit 112 to the image data.

The image capturing unit 112 that is a device capable of capturing an image can be a closed-circuit television (CCTV), a digital camera or a video camera, for example. The image capturing unit 112 includes a lens for condensing light and a charge-coupled device (CCD) for converting the light condensed by the lens into image data, recognizes an object through the lens and images the recognized object to generate an optical image. This optical image can be converted into image data through a CCD sensor. The image data generated by the image capturing unit 112 is transmitted to the image processor 118.

The image processor 118 receives the image data from the image capturing unit 112, processes the image data and embeds signature information in the image data. The image processor 118 can be constructed as additional hardware or included in the image capturing unit 112. In the current embodiment, it is assumed that the image processor 118 exists as an additional module separated from the image capturing unit 112.

The image processor 118 adds at least one of information on the image capturing unit 112 and signature information to the image data transmitted from the image capturing unit 112. By doing so, the image data can be protected from arbitrary access and control. The signature information can be added to the image data at regular intervals.

The image information server 120 stores the image data to which the information on the image capturing unit 112 or the signature information has been added by the image processor 18. The image information server 120 includes a storage unit capable of storing the image data having the information on the image capturing unit 112 or the signature information added thereto and can be connected to a communication network 130 such as the Internet or a mobile communication network to transmit the image data processed by the image processor 118 to a communication terminal. That is, the image data processed by the image processor 118 can be stored in the image information server 120 and applied to the application server 140 through the communication network 130 such as the Internet.

The application server 140 provides a variety of application services to a mobile terminal of a communication service subscriber using the communication network 130 at the request of the communication service subscriber. For example, the application server 140 extracts the stored image data and transmits the image data to a mobile terminal at the request of the user of the mobile terminal. The application server 140 can store the image data to which information such as signature information has been added by the image processor 118 or the image information server 120 and transmit the stored image data to the terminal of the communication service substrate to prevent the image data from being illegally copied and edited.

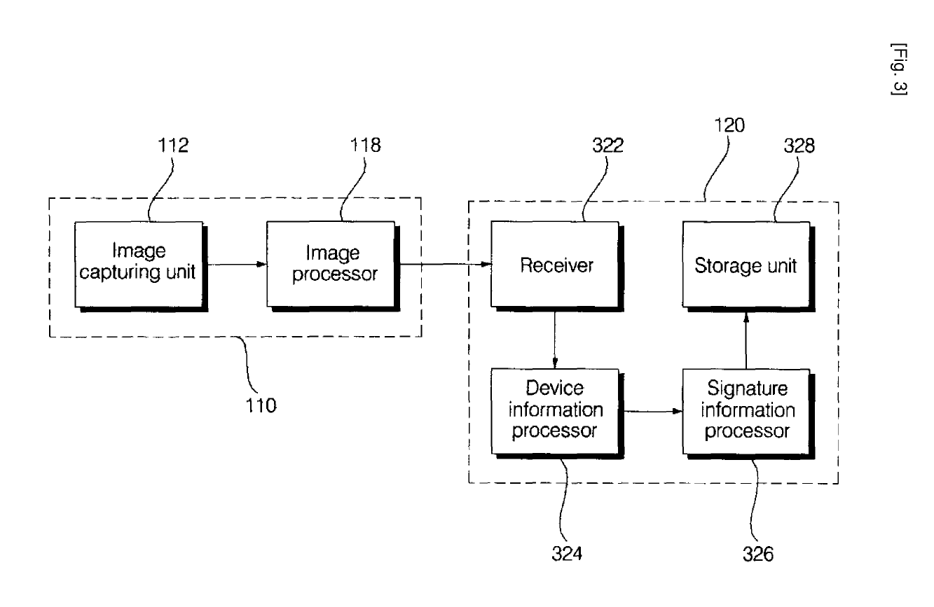

In another embodiment, the image information server 120 can add the signature information or the information on the image capturing unit 112 to the image data captured by the image capturing unit 112. In this case, the image processor 118 transmits the image data and the information on the image capturing unit 112 received from the image capturing unit 112 to the image information server 120, and the image information server 120 adds the information on the image capturing unit 112 or the signature information to the image data transmitted from the image processor 118. The image data processed by the image information server 120 can be applied to the application server 140 through the communication network 130 such as the Internet. This will be explained in more detail later with reference to FIG. 3.

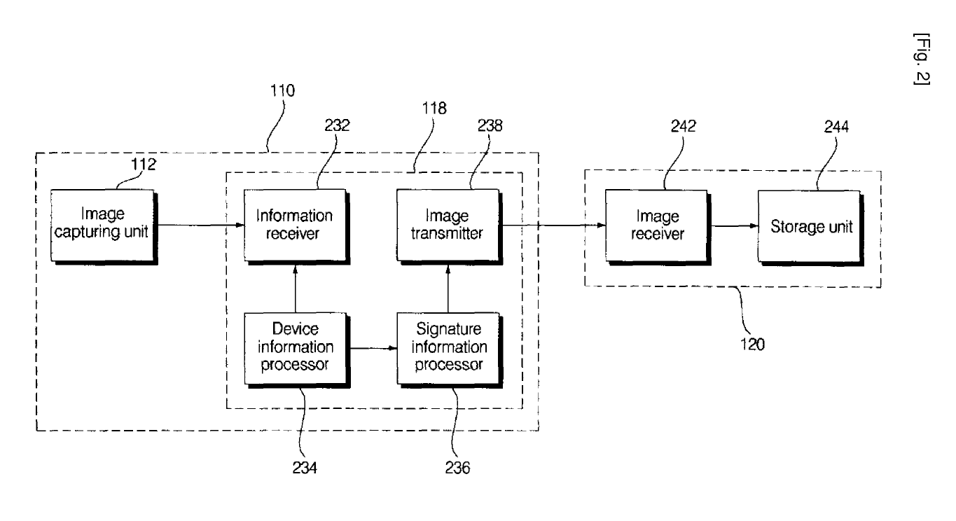

FIG. 2 is a block diagram of the image capturing device 110 and the image information server 120 illustrated in FIG. 1 according to an embodiment of the present invention, which shows a case in which the image processor 118 adds the information on the image capturing unit 112 or the signature information to the image data.

Referring to FIG. 2, the image photographing device 110 includes the image capturing unit 112 and the image processor 118. The image processor 118 includes an information receiver 232, a device information processor 234, a signature information processor 236, and an image transmitter 238. The image information server 120 includes an image receiver 242 and a storage unit 244.

The image capturing unit 112 is a device capable of capturing an image, obtaining image data from the captured image and collecting information on the image capturing unit 112. For example, a CCTV, a digital camera, a video camera or a communication terminal including a camera module can be used as the image capturing unit 112. The image data obtained by the image capturing unit 112 is transmitted to the image processor 118 and undergoes a data processing operation of adding signature information or the information on the image capturing unit 112 thereto.

The image processor 118 adds the information on the image capturing unit 112 or the signature information to the image data generated by the image capturing unit 112. The information receiver 232 included in the image processor 118 receives the image data generated by the image capturing unit 112 and the information on the image capturing unit 112 and the device information processor 234 adds the information on the image capturing unit 112 to the image data transmitted from the information receiver 232. The signature information processor 236 adds the signature information to the image data transmitted from the device information processor 234 and the image transmitter 238 transmits the image data having the information on the image capturing unit 112 or the signature information added thereto to the image information server 120.

Here, positions of the device information processor 234 and the signature information processor 236 can be changed each other. That is, the signature information can be added first, and then the information on the image capturing unit can be added.

The information receiver 232 receives the image data generated by the image capturing unit 112 and transmits the information to the device information processor 234. The information on the image capturing unit 112 can include an identifier given to the image capturing unit 112 or information on the place and time at which the image capturing unit 112 obtains the image data. When the image capturing unit 112 is a CCTV, for example, the information on the image capturing unit 112 can include the place where the CCTV is installed and the time when the CCTV records the image. When the image capturing unit 112 is a communication terminal, the information on the image capturing unit 112 can include an identification number given to the communication terminal.

The device information processor 234 adds the information on the image capturing unit 112 to the image data transmitted from the information receiver 232. That is, the place and time at which the image data is obtained or the identification number of the image capturing unit 112 that captures the image data can be added to the image data as the information on the image capturing unit 112. The image data can be used as digital proof of a specific event when the place and time at which the image data is captured is added thereto and the source of the image data can be easily detected when the identification number of the image capturing unit 112 is added thereto. The device information processor 234 transmits the image data having the information on the image capturing unit 112 added thereto to the signature information processor 236.

The signature information processor 236 can embed signature information including a predetermined encryption key in the image data transmitted from the device information processor 234. According to an embodiment, the signature information processor 236 can add public key based signature information, symmetric key based signature information or public key and symmetric key based signature information to the image data.

The public key based signature information can be generated according to Rivest Shamir Adleman (RSA) algorithm and the symmetric key based signature information can be generated according to Vernam or data encryption standard (DES) algorithm. The symmetric key based signature information requires transmission of an additional secret key and is difficult to authenticate with safety although it is encrypted at a high speed. On the other hand, the public key based signature information does not require transmission of the additional secrete key and is easily authenticated with safety while it is encrypted at a low speed. Accordingly, an algorithm of generating the signature information can be selected according to a degree to which maintenance of security of the image data is required.

When the signature information is added to the image data, the image data can be accessed only using a predetermined decryption key. Accordingly, the possibility that the image data is exposed to hacking or illegal copy according to arbitrary access can be reduced when the signature information is added to the image data. The application server 140 that provides the image data to communication subscribers can provide the decryption key to only an authenticated communication subscriber through a text message to maintain security of the image data.

The signature information can be added to the image data at regular intervals.

The image data having the information on the image capturing unit 112 and the signature information added thereto is transmitted to the image transmitter 238. That is, at least one of the information on the image capturing unit 112 and the signature information is added to the image data transmitted from the image capturing unit 112 and transmitted to the image transmitter 238.

The image transmitter 238 transmits the image data received from the signature information processor 236 to the image information server 120.

The image receiver 242 receives the image data from the image transmitter 238. The storage unit 244 stores the image data transmitted from the image receiver 242. The image data transmitted from the image receiver 242 has at least one of the information on the image capturing unit 112 and the signature information added thereto.

The image information server 120 can determine whether the decryption key transmitted from the application server 130 corresponds to the encryption key embedded in the image data, extract the image data stored in the storage unit 244 and transmit the image data to the application server 140 when the application server 140 requests the image information server 120 to transmit the image data through the communication network 130.

FIG. 3 is a block diagram of the image capturing device 110 and the image information server 120 illustrated in FIG. 1 according to another embodiment of the present invention, which shows a case in which the image information server 120 adds the information on the image capturing unit 112 or the signature information to the image data.

Referring to FIG. 3, the image capturing device 110 includes the image capturing unit 112 and the image processor 118 and the image information server 120 includes a receiver 322, a device information processor 324, a signal information processor 326 and a storage unit 328.

The image capturing unit 112 is a device capable of recognizing an object through a lens and a sensor, obtaining image data from the recognized object and collecting information on the image capturing unit 112. The image processor 118 transmits the image data and the information on the image capturing unit 112 received from the image capturing unit 112 to the image information server 120.

The receiver 322 included in the image information server 120 receives the image data and the information on the image capturing unit 112 transmitted from the image processor 118 and the device information processor 324 receives the image data and the information on the image capturing unit 112 from the receiver 322 and embeds the information on the image capturing unit 112 in the image data. The signature information processor 326 adds predetermined signature information to the image data having the information on the image capturing unit 112 added thereto and the storage unit 328 stores the image data including the signature information.

The receiver 322 receives the image data and the information on the image capturing unit 112 from the image processor 118.

The device information processor 324 embeds the information on the image capturing unit 112 in the image data and transmits the image data to the signature information processor 326. The information on the image capturing unit 112 depends on the type of the image capturing unit 112. For example, when the image capturing unit 112 is a CCTV, the information on the image capturing unit 112 can include the place where the CCTV is installed and the time when the CCTV obtains the image data. When the image capturing unit 112 is a communication terminal including a camera module, the information on the image capturing unit 112 can include the identification number of the communication terminal.

The source of the image data can be easily searched when the identification number of the image capturing unit 112 is embedded in the image data and the image data can be used as digital proof when the place and time at which the image capturing unit 112 captures the image data is added thereto. The information on the image capturing unit 112 can be recorded in a meta data region of the image data.

The signature information processor 326 can embed signature information including a predetermined encryption key in the image data transmitted from the device information processor 324.

The signature information processor 326 can generate the signature information according to a predetermined algorithm and embed the signature information in the image data. The signature information can be generated according to a public key based algorithm or a symmetric key based algorithm. In general, the case that the image information server 120 embeds the information on the image capturing unit 112 and the signature information in the image data requires a data processing speed and available capacity greater than the data processing speed and available capacity required for the case that the image photographing device 110 embeds the information on the image capturing unit 112 and the signature information in the image data. Accordingly, it is desirable to generate the signature information using the public key based algorithm that easily performs safe authentication and does not require an addition secret key to be transmitted while having a low encryption speed. The image data to which the signature information has been added is stored in the storage unit 328 of the image information server 120.

The signature information can be added to the image data at regular intervals.

The storage unit 328 stores the image data transmitted from the signature information processor 326. The image data transmitted from the signature information processor 326 has at least one of the information on the image capturing unit 112 and the signature information added thereto.

The image information server 120 can receive a predetermined decryption key from the application server 140 and compare the decryption key with the encryption key included in the image data to determine whether the image data is transmitted when the application server 140 requests the image information server 120 to transmit the image data through the communication network 130.

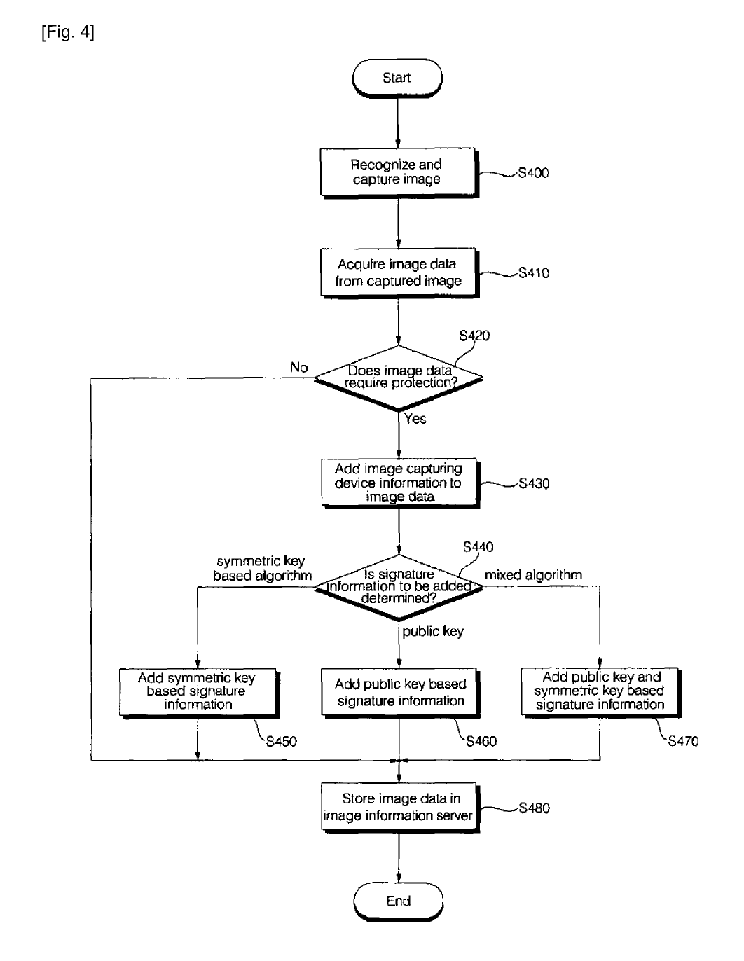

FIG. 4 is a flow chart of an image information processing method using the image photographing system illustrated in FIG. 1.

Referring to FIG. 4, the image capturing unit 112 included in the image capturing device 110 recognizes an image and captures the image in operation S400.

Then, the image capturing unit 112 acquires image data from the image captured in operation S400. For example, the image capturing unit 112 included in the image capturing device 110 can condense light through a lens and convert the light that has passed through the lens into image data using a CCD sensor.

The image data can include meta data and main data. The main data can include information on the captured image and the meta data can include information that explains the main data.

When the image data is obtained, the image capturing device 110 determines whether it is required to protect the image data in operation S420. It can be determined whether the image data requires protection according to the type of the image capturing device 110 or setting up by a user who captures the image.

When it is determined that the image data does not require protection in operation S420, the image data is transmitted to the image information server 120 without undergoing additional image data processing in operation 5480.

When it is determined that the image data requires protection in operation S420, information on the image capturing device 100 is added to the image data in operation S430. For example, the information on the image capturing device 110 can correspond to information on the image capturing unit 112 that captures the image data and be added to the image data by the image processor 118 of the image capturing device 110 or the image information server 120. That is, when the image processor 118 is configured in the form of a module independent from the image capturing unit 112 or has sufficient data processing speed and capacity, the image processor 118 can add the information on the image capturing device 110 to the image data. However, when the image processor 118 do no have sufficient data processing speed and capacity or is configured in the form of software installed in the image capturing unit 112, the image information server 120 can add the information on the image capturing device 110 to the image data.

When the information on the image capturing device 110 is embedded in the image data in operation S430, the type of signature information to be added to the image data is determined in operation S440. The signature information can be generated according to symmetric key based algorithm, public key based algorithm or public key and symmetric key based algorithm and embedded in the image data.

When the signature information according to the symmetric key based algorithm is embedded in the image data in operation S450, safe authentication is difficult to perform and an additional secret key is required although encryption speed is high due to low algorithm complexity. Accordingly, it is desirable to use the symmetric key based algorithm in consideration of data processing load applied to the image processor 118 in the case where the image processor 118 embeds the signature information in the image data.

When the signature information according to the public key based algorithm is embedded in the image data in operation S460, safe authentication can be achieved and transmission of an additional secret key is not needed in spite of high algorithm complexity. Accordingly, it is desirable to use the public key based algorithm using the data processing speed and capacity of the image information server 120, which are greater than those of the image processor 118 when the image information server 120 embeds the signature information in the image data.

When the signature information according to the public key and symmetric key mixed algorithm is embedded in operation S470, a public key is generated using the public key based algorithm first, and then a data encryption key with respect to the public key based algorithm is generated using the symmetric key based algorithm. Although the public key and symmetric key mixed algorithm can secure safe authentication as compared to the cases where the public key based algorithm and symmetric key based algorithm are used in operations S450 and S460, it is desirable to use the mixed algorithm when the image information server 120 can embed the signature information in the image data because algorithm complexity is high.

The signature information can be added to the image data at regular intervals.

When the signature information has been embedded in the image data in operations S450, S460 and S470, the image data having the signature information added thereto is stored in the image information server 120 in operation S480. When the application server 140 requests the image information server 120 to transmit the image data through the communication network 130, the image information server 120 can compare the decryption key transmitted from the application server 140 with the encryption key included in the image data stored in the image information server 120 to determine whether the requested image data is transmitted.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, image data can be protected from security infringement such as illegal copy and arbitrary transmission. Furthermore, information on the place and time at which an image is captured is added to the image data such that the image data can be used as digital proof.

1. An apparatus for processing image information comprising:
an image capturing unit for generating image data and collecting information on the image capturing unit;
an image processing unit for adding at least one of the information on the image capturing unit and signature information to the image data using the image data and the information on the image capturing unit transmitted from the image capturing unit; and
an image storage unit for storing the image data output from the image processing unit.

2. The apparatus of claim 1, wherein the image processing unit comprises:
a device information processor for embedding the information on the image capturing unit in the image data; and
a signature information processor for embedding the signature information in the image data.

3. The apparatus of claim 2, wherein the signature information processor adds the signature information to the image data using at least one of a public key base algorithm and a symmetric key based algorithm.

4. The apparatus of claim 1, wherein the information on the image capturing unit corresponds to information on the place and time at which the image capturing unit obtains the image data.

5. The apparatus of claim 1, wherein the signature information is added to the image data at regular intervals.

6. The apparatus of claim 1, further comprising an image authentication unit for comparing the signature information with a decryption key and determining whether the image data output from the image processing unit is transmitted when the image data is requested to be transmitted and the decryption key is transmitted thereto.

7. A method for processing image information comprising:
an image capturing step of generating image data and collecting information on the image capturing step;
an image processing step of adding at least one of the information on the image capturing step and signature information to the image data; and
an image storing step of storing the image data.

8. The method of claim 7, wherein the image processing step comprises:
a device information processing step of embedding the information on the image capturing step in the image data; and
a signature information processing step of embedding the signature information in the image data.

9. The method of claim 8, wherein the signature information processing step adds the signature information to the image data using at least one of a public key base algorithm and a symmetric key based algorithm.

10. The method of claim 7, wherein the information on the image capturing step corresponds to information on the place and time at which the image data is obtained.

11. The method of claim 7, wherein the signature information is added to the image data at regular intervals.

12. The method of claim 7, further comprising an image authentication step of comparing the signature information with a decryption key and determining whether the image data output from the image processing step is transmitted when the image data is requested to be transmitted and the decryption key is transmitted.

13. An apparatus for processing image information using image data, comprising:
a device information unit for embedding information on the device that generates the image data in the image data;
a signature information unit for embedding signature information in the image data; and
a storage unit for storing the image data having at least one of the information on the device and the signature information added thereto.

14. The apparatus of claim 13, wherein the information on the device corresponds to information on the place and time at which the image data is obtained.

15. The apparatus of claim 13, wherein the signature information unit adds the signature information to the image data using at least one of a public key base algorithm and a symmetric key based algorithm.

16. The apparatus of claim 13, wherein the signature information is added to the image data at regular intervals.

17. The apparatus of claim 13, further comprising an image authentication unit for comparing the signature information with a decryption key and determining whether the image data stored in the storage unit is transmitted when the image data is requested to be transmitted and the decryption key is transmitted thereto.

18. A method for processing image information using image data, comprising:
a device information step of embedding information on the device that generates the image data in the image data;
a signature information step of embedding signature information in the image data; and
a storing step of storing the image data having at least one of the information on the device and the signature information added thereto.

19. The method of claim 18, wherein the information on the device corresponds to information on the place and time at which the image data is obtained.

20. The method of claim 18, wherein the signature information step adds the signature information to the image data using at least one of a public key base algorithm and a symmetric key based algorithm.

21. The method of claim 18, wherein the signature information is added to the image data at regular intervals.

22. The method of claim 18, further comprising an image authentication step of comparing the signature information with a decryption key and determining whether the image data stored in the storing step is transmitted when the image data is requested to be transmitted and the decryption key is transmitted.
